(19) United States
(12) Patent Application Publication
(10) Pub. No.: US 2015/0351208 A1
(43) Pub. Date: Dec. 3, 2015

(54) LASER APPARATUS AND EXTREME ULTRAVIOLET LIGHT GENERATION SYSTEM

(71) Applicant: GIGAPHOTON INC., Tochigi (JP)

(72) Inventors: Takashi SUGANUMA, Tochigi (JP); Toru SUZUKI, Tochigi (JP); Takahisa FUJIMAKI, Tochigi (JP); Yoshiaki KUROSAWA, Tochigi (JP)

(73) Assignee: c/o GIGAPHOTON INC., Tochigi (JP)

(21) Appl. No.: 14/737,262

(22) Filed: Jun. 11, 2015

Related U.S. Application Data
(63) Continuation of application No. PCT/JP2013/084695, filed on Dec. 25, 2013.

(30) Foreign Application Priority Data
Jan. 31, 2013 (JP) 2013-017271

(51) Int. Cl. H05G 2/00; H01S 3/00; G02F 1/09; H01S 3/10; G02F 1/01; H01S 3/23; H01S 3/223

(52) U.S. Cl. CPC H05G 2/008; H01S 3/2316; H01S 3/005; H01S 3/0078; H01S 3/2232; H05G 2/003; H01S 3/10023; G02F 1/0136; H01S 3/0085; G02F 1/09

(57) ABSTRACT

There may be included: a master oscillator configured to output pulsed laser light; a power amplifier disposed in an optical path of the pulsed laser light to amplify the pulsed laser light; and a wavelength filter disposed between the master oscillator and the power amplifier in the optical path of the pulsed laser light, and configured to allow the pulsed laser light to pass therethrough and suppress transmission of light with a wavelength other than a wavelength of the pulsed laser light.

### TECHNICAL FIELD

The present disclosure relates to a laser apparatus and an extreme ultraviolet light generation system.

### BACKGROUND ART

In recent years, microfabrication of transfer patterns in photolithography in semiconductor processes has been rapidly developed with microfabrication in the semiconductor processes. In the next generation, microfibrication processing in a range from 70 nm to 45 nm, and further microfabrication processing in a range of 32 nm or less may be demanded. Therefore, for example, to meet the demand for microfabrication processing in the range of 32 nm or less, it is expected to develop exposure apparatuses configured of a combination of an apparatus that is configured to generate extreme ultraviolet (EUV) light with a wavelength of about 13 nm and a catadioptric system.

Three kinds of EUV light generation systems have been proposed, that include an LPP (Laser Produced Plasma) system using plasma generated by irradiating a target material with laser light, a DPP (Discharge Produced Plasma) system using plasma generated by electric discharge, and an SR (Synchrotron Radiation) system using synchrotron radiation.

### CITATION LIST

### Patent Literature

### PTL 1: Japanese Unexamined Patent Application Publication No. 2010-103104

### PTL 2: Japanese Patent No. 5086677

### PTL 3: Japanese Unexamined Patent Application Publication No. 2008-283107

### PTL 4: Specification of U.S. Patent Application Publication No. 2011/0058588

### PTL 5: Specification of U.S. Patent Application Publication No. 2012/0193547

### SUMMARY

A laser apparatus may include: a master oscillator configured to output pulsed laser light; a power amplifier disposed in an optical path of the pulsed laser light to amplify the pulsed laser light; and a wavelength filter disposed between the master oscillator and the power amplifier in the optical path of the pulsed laser light, and configured to allow the pulsed laser light to pass therethrough and suppress transmission of light with a wavelength other than a wavelength of the pulsed laser light.

Moreover, a laser apparatus may include: a master oscillator configured to output pulsed laser light; two or more power amplifiers disposed in an optical path of the pulsed laser light to amplify the pulsed laser light; and a wavelength filter disposed between adjacent two of the power amplifiers in the optical path of the pulse light, and configured to allow the pulsed laser light to pass therethrough and suppress transmission of light with a wavelength other than a wavelength of the pulsed laser light.

Further, a laser apparatus may include: a master oscillator configured to output pulsed laser light; two or more power amplifiers disposed in an optical path of the pulsed laser light to amplify the pulsed laser light; and a first polarizer, a Pockets cell, a retarder, and a second polarizer that are provided between adjacent two of the power amplifiers in the optical path of the pulsed laser light.

Furthermore, a laser apparatus may include: a master oscillator configured to output pulsed laser light; two or more power amplifiers disposed in an optical path of the pulsed laser light to amplify the pulsed laser light; and a first polarizer, a Faraday rotator, and a second polarizer that are provided between adjacent two of the power amplifiers in the optical path of the pulsed laser light.

### BRIEF DESCRIPTION OF DRAWINGS

Some embodiments of the disclosure are described below as mere examples with reference to the accompanying drawings.

FIG. 1 is a schematic configuration diagram of an exemplary laser produced plasma (LPP) extreme ultraviolet (EUV) light generation system according to an embodiment of the present disclosure.

FIG. 2 is a configuration diagram of a laser apparatus that outputs CO₂ laser light used for the LPP-EUV light generation system.

FIG. 3 is a relationship diagram between an amplification line and a gain in a case where CO₂ laser gas serves as a gain medium.

FIG. 4 is a configuration diagram of a laser apparatus including a wavelength filter of the present disclosure.

FIG. 5 is a configuration diagram of a wavelength filter in which a multilayer film is formed.

FIG. 6 is a characteristic diagram of reflectivity of the wavelength filter in which the multilayer film is formed.

FIG. 7 is a configuration diagram of a wavelength filter using a plurality of polarizers.

FIG. 8 is a characteristic diagram of reflectivity of the wavelength filter using the plurality of polarizers.

FIG. 9 is a configuration diagram of a wavelength filter using an etalon.

FIG. 10 is a characteristic diagram of reflectivity of the wavelength filter using the etalon.

FIG. 11 is a configuration diagram of a wavelength filter including a grating and a slit.

FIG. 12 is a characteristic diagram of reflectivity of the wavelength filter including the grating and the slit.

FIG. 13 is a configuration diagram of a laser apparatus including an optical isolator of the present disclosure.

FIG. 14 is an explanatory diagram of an optical isolator configured of a combination of a wavelength filter and an EO Pockets cell.

FIG. 15 is an explanatory diagram of a control circuit of a laser apparatus including the optical isolator of the present disclosure.

FIG. 16 is an explanatory diagram of control by the control circuit of the laser apparatus including the optical isolator of the present disclosure.

FIG. 17 is an explanatory diagram of an optical isolator configured of a combination of a wavelength filter and a Faraday rotator.

FIG. 18 is an explanatory diagram of the Faraday rotator.

FIG. 19 is an explanatory diagram of an optical isolator including a reflective polarizer.

FIG. 20 is an explanatory diagram of a polarizer.

### EMBODIMENTS

In the following, some embodiments of the disclosure are described in detail with reference to the drawings. Embodiments described below each illustrates one example of the disclosure and are not intended to limit the contents of the disclosure. Also, all of the configurations and operations described in each embodiment are not necessarily essential for the configurations and operations of the disclosure. Note that the like elements are denoted with the same reference numerals, and any redundant description thereof is omitted.

Contents

1. Description of terms
2. Overview of EUV light generation system

2.1 Configuration

2.2 Operation

3. Laser apparatus including master oscillator and amplifier

3.1 Configuration

3.2 Operation

3.3 Problem

4. Laser apparatus including wavelength filter

4.1 Configuration

4.2 Operation

4.3 Action

5. Wavelength filter

5.1 Wavelength filter in which multilayer film is formed

5.2 Wavelength filter using a plurality of polarizers

5.3 Wavelength filter using etalon

5.4 Wavelength filter including grating and slit

6. Combination of wavelength filter and EO Pockels cell

6.1 Configuration

6.2 Operation

6.3 Control
6.3.1 Configuration of control circuit
6.3.2 Operation of control circuit

6.4 Action

7. Combination of wavelength filter and Faraday rotator

7.1 Configuration

7.2 Operation

7.3 Action

7.4 Optical isolator including reflective polarizer

### 8. Polarizer

1. Description of Terms

Terms used in the present disclosure will be defined as follows. The term “plasma generation region” refers to a region where plasma is generated by irradiating a target material with pulsed laser light. The term “droplet” refers to a liquid droplet and a sphere. The term “optical path” refers to a path through which laser light passes. The term “optical path length” refers to a product of a distance where light actually travels and a refractive index of a medium through which the light passes. The term “amplification wavelength range” refers to a wavelength band that is amplifiable when laser light passes through an amplification region.

The side closer to a master oscillator along an optical path of laser light is referred to as “upstream”. Moreover, the side closer to the plasma generation region along the optical path of the laser light is referred to as “downstream”. The optical path may refer to an axis passing through a nearly center of a beam section of laser light along a traveling direction of the laser light.

In the present disclosure, a traveling direction of laser light is defined as “Z direction”. Moreover, one direction perpendicular to this Z direction is defined as “X direction”, and a direction perpendicular to the X direction and the Z direction is defined as “Y direction”. Although the traveling direction of laser light refers to the Z direction, in the description, the X direction and Y direction may change depending on the position of laser light that is to be mentioned. For example, in a case where the traveling direction (Z direction) of laser light changes in an X-Z plane, after the traveling direction changes, the X direction may change depending on such change in the traveling direction, but the Y direction may not change. On the other hand, in a case where the traveling direction (Z direction) of laser light changes in a Y-Z plane, after the traveling direction changes, the Y direction may change depending on such change in the traveling direction, but the X direction may not change.

In a reflective optical device, in a case where a plane including both an optical axis of laser light entering the optical device and an optical axis of laser light reflected by the optical device serves as an incident plane, “S-polarization” refers to a polarization state along a direction perpendicular to the incident plane. On the other hand, “P-polarization” refers to a polarization state along a direction orthogonal to an optical path and parallel to the incident plane.

2. Overview of EUV light generation system

2.1 Configuration

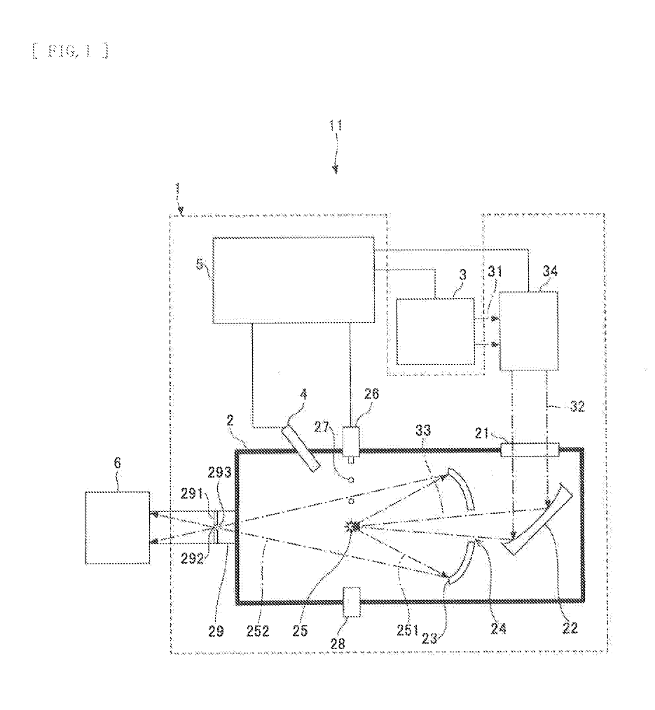

FIG. 1 schematically illustrates a configuration of an exemplary LPP-EUV light generation system. An EUV light generation system 1 may be used together with at least one laser apparatus 3. In this application, a system including the EUV light generation system 1 and the laser apparatus 3 is referred to as “EUV light generation system 11”. As illustrated in FIG. 1 and as will be described in detail below, the EUV light generation system 1 may include a chamber 2 and a target feeding section 26. The chamber 2 may be hermetically sealable. The target feeding section 26 may be so mounted as to penetrate a wall of the chamber 2, for example. A material of a target material that is to be fed from the target feeding section 26 may include tin, terbium, gadolinium, lithium, xenon, or a combination of any two or more of them, but is not limited thereto.

The chamber 2 may include at least one through hole in its wall. A window 21 may be provided at the through hole, and pulsed laser light 32 outputted from the laser apparatus 3 may pass through the window 21. For example, an EUV collector mirror 23 with a spheroidal reflective surface may be provided in the chamber 2. The EUV collector minor 23 may be provided with a first focal point and a second focal point. For example, a multilayer reflective film in which molybdenum and silicon are alternately laminated may be formed on a surface of the EUV collector mirror 23. The EUV collector mirror 23 may be preferably so disposed that the first focal point and the second focal point are located in a plasma generation region 25 and an intermediate condensing point (IF) 292, respectively, for example. A through hole 24 may be provided in a central portion of the EUV collector mirror 23, and pulsed laser light 33 may pass through the through hole 24.

The EUV light generation system 1 may include an EUV light generation control section 5, a target sensor 4, and the like. The target sensor 4 may be provided with an image pickup function, and may be configured to detect the presence, trajectory, position, speed, and the like of a target 27.

Moreover, the EUV light generation system 1 may include a connection section 29 that allows the interior of the chamber 2 to communicate with the interior of an exposure apparatus 6. A wall 291 in which an aperture 293 is formed may be provided in the connection section 29. The wall 291 may be so disposed that the aperture 293 is placed at the position of the second focal point of the EUV collector minor 23.

Further, the EUV light generation system 1 may include a laser light traveling direction control section 34, a laser light collecting mirror 22, a target collection section 28 configured to collect the target 27, and the like. The laser light traveling direction control section 34 may include an optical device configured to define the traveling direction of laser light, and an actuator configured to adjust the position, posture, and the like of the optical device.

2.2 Operation

With reference to FIG. 1, pulsed laser light 31 outputted from the laser apparatus 3 may travel through the laser light traveling direction control section 34, and the pulsed laser light 31 having traveled through the laser light traveling direction control section 34 may pass through the window 21 as pulsed laser light 32 to enter the chamber 2. The pulsed laser light 32 may travel in the chamber 2 along at least one laser light path, and may be reflected by the laser light collecting mirror 22 to be applied as pulsed laser light 33 to at least one target 27.

The target feeding section 26 may be configured to output the target 27 to the plasma generation region 25 in the chamber 2. The target 27 may be irradiated with at least one pulse included in the pulsed laser light 33. The target 27 irradiated with pulsed laser light may be turned into plasma, and radiation light 251 may be outputted from the plasma. EUV light 252 included in the radiation light 251 may be selectively reflected by the EUV collector mirror 23. The EUV light 252 reflected by the EUV collector minor 23 may be condensed on the intermediate condensing point 292 to be outputted to the exposure apparatus 6. It is to be noted that a plurality of pulses included in the pulsed laser light 33 may be applied to one target 27.

The EUV light generation control section 5 may be configured to control the overall EUV light generation system 11. The EUV light generation control section 5 may be configured to process image data or the like of the target 27 that is imaged by the target sensor 4. Moreover, the EUV light generation control section 5 may be configured to control, for example, a timing at which the target 27 is outputted, a direction where the target 27 is outputted, and the like. Further, the EUV light generation control section 5 may be configured to control, for example, an oscillation timing of the laser apparatus 3, a traveling direction of the pulsed laser light 32, a position where the pulsed laser light 33 is condensed, and the like. The above-described various controls are merely examples, and any other control may be added as necessary.

3. Laser Apparatus Including Master Oscillator and Amplifier

Incidentally, the LPP-EUV light generation system may include a CO₂ laser apparatus as the laser apparatus 3. The CO₂ laser apparatus used as the laser apparatus 3 may be desired to output pulsed laser light with high pulse energy at a high repetition frequency. Therefore, the laser apparatus 3 may include a master oscillator (MO) configured to output pulsed laser light at a high repetition frequency and a plurality of power amplifiers (PAs) each of which is configured to amplify pulsed laser light.

In this case, the CO₂ laser apparatus configured of a combination of the MO and the plurality of PAs holds a possibility of causing self-oscillation by amplified spontaneous emission (ASE) light outputted from the power amplifier irrespective of a pulse outputted from the MO.

It was found that, as such self-oscillating light, not only light with a wavelength of 10.59 μm serving as seed light but also ASE light with a wavelength of 9.27 μm, ASE light with a wavelength of 9.59 μm, and ASE light with a wavelength of 10.24 μm are outputted. Therefore, it is desirable that self-oscillation by light with the wavelength of 9.27 μm, light with the wavelength of 9.59 μm, and light with the wavelength of 10.24 μm be suppressed. It is to be noted that, in this application, pulsed laser light outputted from an MO 110 and pulsed laser light derived from amplification of the pulsed laser light outputted from the MO 110 by the power amplifier may be referred to as “pulsed laser light” or “seed light”.

3.1 Configuration

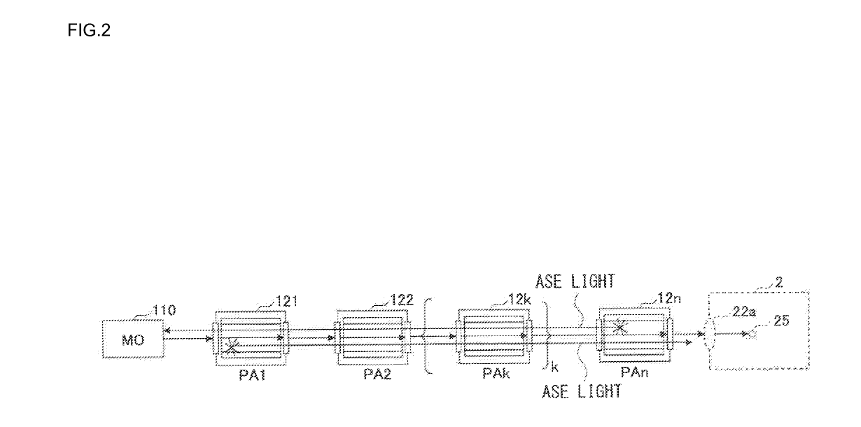

With reference to FIG. 2, a laser apparatus used in the LPP-EUV light generation system will be described below. A laser apparatus illustrated in FIG. 2 may include the MO 110 and at least one or more power amplifiers, for example, power amplifiers 121, 122, . . . , 12k, . . . , and 12n. It is to be noted that the power amplifiers 121, 122, . . . , 12k, . . . , and 12n may be denoted to as PA1, PA2, . . . , PAk, . . . , and PAn, respectively, in drawings and the like.

The MO 110 may be a laser oscillator including a Q switch, a CO₂ laser gas medium, and an optical resonator. The one or more power amplifiers, for example, the power amplifiers 121, 122, . . . , 12k, . . . , and 12n may be disposed in an optical path of pulsed laser light outputted from the MO 110. The one or more power amplifiers, for example, each of the power amplifiers 121, 122, . . . , 12k, . . . , and 12n may be a power amplifier in which a pair of electrodes is provided in a chamber containing CO₂ laser gas. In the power amplifiers, a window configured to allow pulsed laser light to pass through the chamber 2 may be provided.

Moreover, the MO 110 may be a quantum cascade laser (QCL) that oscillates in a wavelength band of CO₂ laser light. In this case, pulsed laser light may be outputted by controlling a pulse current that flows through the quantum cascade laser serving as the MO 110.

3.2 Operation

The power amplifiers 121, 122, . . . , 12k, . . . , and 12n each may apply a potential between a pair of electrodes by their respective power supplies that are unillustrated to perform electric discharge. Laser oscillation may be caused by operating the Q switch of the MO 110 at a predetermined repetition frequency. As a result, pulsed laser light may be outputted from the MO 110 at the predetermined repetition frequency.

Even in a case where pulsed laser light outputted from the MO 110 does not enter the power amplifiers 121, 122, . . . , 12k, . . . , and 12n, the power amplifiers 121, 122, . . . , 12k, and 12n may perform electric discharge by an unillustrated power supply to excite CO₂ laser gas. The pulsed laser light outputted from the MO 110 may enter the power amplifier 121 and pass through the inside of the power amplifier 121 to be subjected to amplification, following which the thus-amplified pulsed laser light may be outputted. The amplified pulsed laser light outputted from the power amplifier 121 may enter the power amplifier 122 and pass through the inside of the power amplifier 122 to be subjected to further amplification, following which the thus-amplified pulsed laser light may be outputted. Likewise, pulsed laser light outputted from an unillustrated power amplifier 12k-1 may enter the power amplifier 12k and pass through the inside of the power amplifier 12k to be subjected to further amplification, following which the thus-amplified pulsed laser light may be outputted. Then, pulsed laser light outputted from an unillustrated power amplifier 12n-1 may enter the power amplifier 12n and pass through the inside of the power amplifier 12n to be subjected to further amplification, following which the thus-amplified pulsed laser light may be outputted. The pulsed laser light outputted from the power amplifier 12n may enter the chamber 2, and the thus-entered pulsed laser light may be condensed on the plasma generation region 25 by a laser light condensing optical system 22a to be applied to a target in the plasma generation region 25. It is to be noted that the laser light condensing optical system 22a may be configured of a reflective optical device or a plurality of reflective optical devices corresponding to the laser light collecting mirror 22 illustrated in FIG. 1, or may be a refractive optical system including a lens. In this application, as the laser light condensing optical device, the laser light condensing optical system 22a and the laser light collecting minor 22 may be included.

3.3 Problem

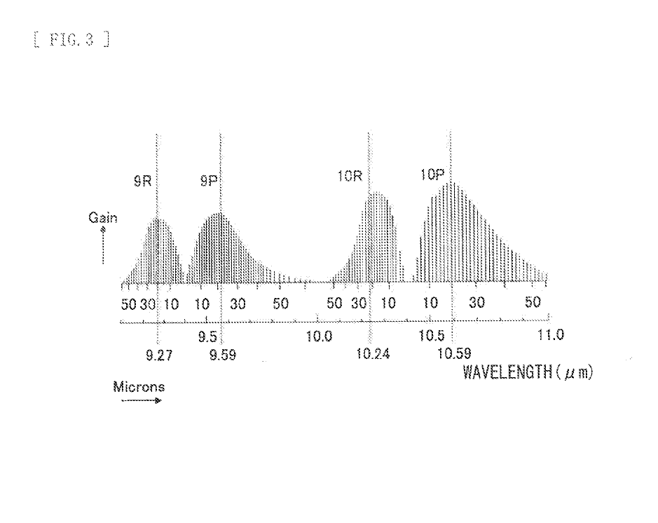

Here, ASE light may be generated in the power amplifier 12n, and the generated ASE light may travel toward a direction where the MO 110 is provided, and may be amplified and self-oscillate by the plurality of power amplifiers 121, 122, . . . , 12k, . . . , and 12n-1. Moreover, ASE light may be generated in the power amplifier 121, and the generated ASE light may travel toward a direction where the chamber 2 is provided, and may be amplified and self-oscillate by the plurality of power amplifiers 122, . . . , 12k, . . . , and 12n. ASE light generated in one of the power amplifiers may be amplified and self-oscillate by the other power amplifiers in such a manner. The inventors found that, in a case where CO₂ laser gas serves as a gain medium, as illustrated in Table 1 and FIG. 3, self-oscillation may be caused in four wavelength bands. FIG. 3 illustrates a relationship between an amplification line and a gain in a case where the CO₂ laser gas serves as a gain medium.

TABLE 1

| Gain Line | 9R(20) | 9P(24) | 10R(20) | 10P(20) |
|---|---|---|---|---|
| Wavelength of Output | 9.27 | 9.59 | 10.24 | 10.59 |
| Laser Light (μm) | | | | |

More specifically, in a case where the CO₂ laser gas serves as a gain medium, it was found that self-oscillation may be caused in a 9.27-μm wavelength band (9R), a 9.59-μm wavelength band (9P), a 10.24-μm wavelength band (10R), and a 10.59-μm wavelength band (10P). In these wavelength bands, the gain is large, and self-oscillation is easily caused by the plurality of power amplifiers 121, 122, . . . , 12k, . . . , and 12n. ASE light in the 9.27-μm wavelength band, ASE light in the 9.59-μm wavelength band, and ASE light in the 10.24-μm wavelength band, other than ASE light in the 10.59-μm wavelength band that serves as seed light, may cause a reduction in output of pulsed laser light outputted from the laser apparatus or an adverse effect on a pulse waveform. As a result, output of EUV light may be reduced.

4. Laser apparatus including wavelength filter

4.1 Configuration

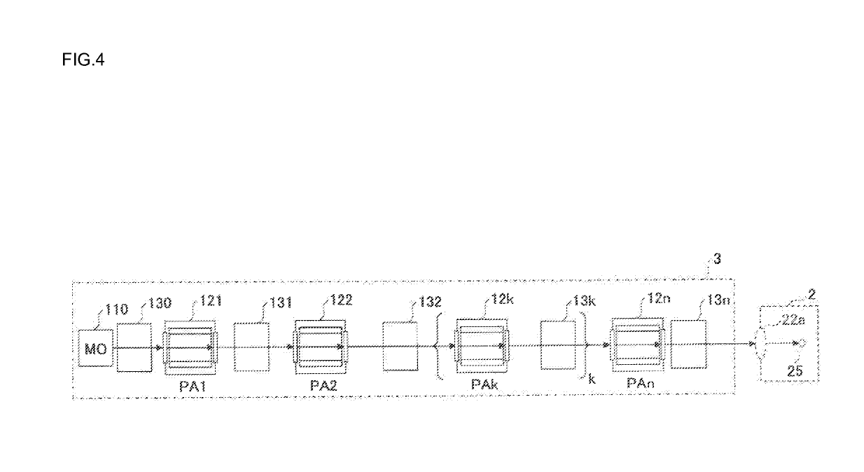

Next, the laser apparatus 3 of the present disclosure will be described below with reference to FIG. 4. In the laser apparatus 3 of the present disclosure, a wavelength filter 130 may be disposed between the MO 110 and the power amplifier 121. Moreover, corresponding one of wavelength filters 131, 132, . . . , 13k, . . . , and 13n-1 may be disposed between power amplifiers adjacent to each other, i.e., between every adjacent two of the power amplifiers 121, 122, . . . , 12k, . . . , and 12n. Further, a wavelength filter 13n may be disposed between the power amplifier 12n and the chamber 2. It is to be noted that the laser apparatus of the present disclosure may be a laser apparatus in which at least one of the wavelength filters 130, 131, 132, . . . , 13k, . . . , 13n-1, and 13n is disposed in an optical path of pulsed laser light in the laser apparatus. The wavelength filters 130, 131, 132, . . . , 13k, . . . , 13n-1, and 13n may be optical systems each of which allows the 10.59 μm wavelength band serving as seed light to pass therethrough at high transmittance, and suppresses transmission of ASE light in the 9.27-μm wavelength band, ASE light in the 9.59-μm wavelength band, and ASE light in the 10.24 μm wavelength band outputted from the power amplifier 121 and the like.

4.2 Operation

The wavelength filter 13k and the like may allow the 10.59-μm wavelength band serving as seed light to pass therethrough at high transmittance, and may suppress transmission of ASE light in the 9.27 μm wavelength band, ASE light in the 9.59-μm wavelength band, and ASE light in the 10.24-μm wavelength band. Therefore, self-oscillation by the ASE light in the 9.27-μm wavelength band, the ASE light in the 9.59-μm wavelength band, and the ASE light in the 10.24-μm wavelength band may be suppressed.

4.3 Action

Self-oscillation by the ASE light in the 9.27-μm wavelength band, the ASE light in the 9.59-μm wavelength band, and the ASE light in the 10.24-μm wavelength band may be suppressed by providing the wavelength filter 13k and the like in the optical path of the pulsed laser light.

It is to be noted that a case is described above where the wavelength filter 13k and the like are directed to the 10.59 μm wavelength band for the wavelength of pulsed laser light outputted from the MO 110; however, the wavelength filter 13k and the like are not limited to this wavelength band.

For example, in a case of the 10.24-μm wavelength band for the wavelength of the pulsed laser light outputted from the MO 110, a wavelength filter for the 10.24-μm wavelength band may be provided. More specifically, a wavelength filter that allows the 10.24-μm wavelength band to pass therethrough at high transmittance and reflects the 9.27-μm wavelength band, the 9.59-μm wavelength band, and the 10.59-μm wavelength band at high reflectivity may be provided.

Moreover, in a case of the 9.59-μm wavelength band for the wavelength of the pulsed laser light outputted from the MO 110, a wavelength filter for the 9.59-μm wavelength band may be provided. More specifically, a wavelength filter that allows the 9.59-μm wavelength band to pass therethrough at high transmittance and reflects the 9.27-μm wavelength band, the 10.24-μm wavelength band, and the 10.59-μm wavelength band at high reflectivity may be provided.

Likewise, in a case of the 9.27-μm wavelength band for the wavelength of the pulsed laser light outputted from the MO 110, a wavelength filter for the 9.27-μm wavelength band may be provided. More specifically, a wavelength filter that allows the 9.27-μm wavelength band to pass therethrough at high transmittance and reflects the 9.59-μm wavelength band, the 10.24-μm wavelength band, and the 10.59-μm wavelength band at high reflectivity may be provided.

As will be described later, the wavelength filter 13k and the like may be an optical device in which a substrate allowing the pulsed laser light to pass therethrough is coated with a multilayer film, or may be a wavelength selection device such as a grating or an air-gap etalon.

Moreover, in a case where a polarizer possible to serve also as a wavelength filter is allowed to be designed, the wavelength filter may not be provided. An example of such a polarizer possible to serve also as a wavelength filter may be a polarizer that reflects light in the 9.27-μm wavelength band, the light in the 9.59-μm wavelength band, and the light in the 10.24-μm wavelength band, and S-polarized light in the 10.59-μm wavelength band at high reflectivity and allows P-polarized light in the 10.59-μm wavelength band to pass therethrough at high transmittance.

Moreover, each of the wavelength filter 13k and the like may be configured of a combination of a plurality of polarizers.

Corresponding one of the wavelength filter 13k and the like may be preferably provided between every adjacent two of all of the power amplifier 12k and the like. Accordingly, ASE light generated in the power amplifier 12k and the like is allowed to be suppressed between every adjacent two of the power amplifier 12k and the like; therefore, an effect of suppressing self-oscillation is possible to be enhanced.

Although description is given of the MO 110 in which a laser oscillator oscillates based on a single line, the MO 110 is not limited thereto. A laser oscillator may oscillate based on a plurality of lines (P(22), P(20), P(18), P(16), and the like) in the 10.59-μm wavelength band. Moreover, a plurality of single longitudinal mode quantum cascade lasers that oscillate based on these lines are included, and in which multiplexing based on the respective lines is performed by a grating.

5. Wavelength Filter

5.1 Wavelength Filter in which Multilayer Film is Formed

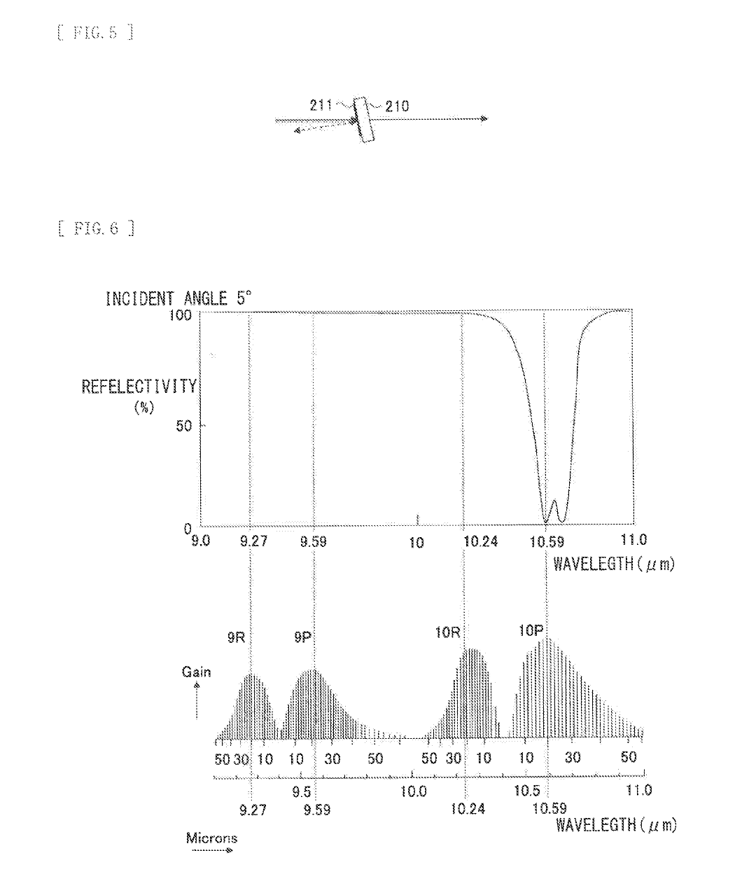

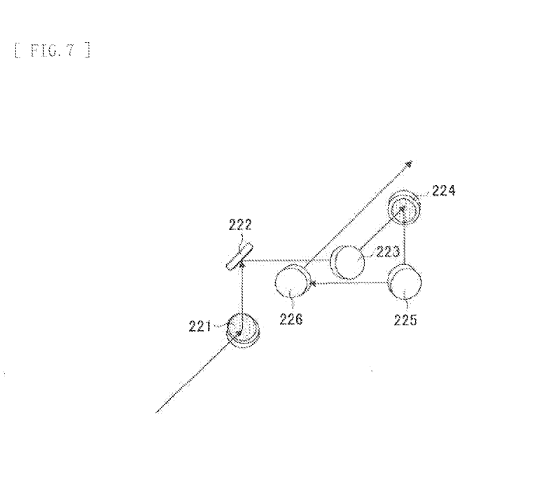

As illustrated in FIG. 5, each of the wavelength filter 13k and the like may be an optical device in which a wavelength-selective transmission film 211 is formed on a surface of the substrate 210 that allows CO₂ laser light to pass therethrough. The substrate 210 may be formed of ZnSe, GaAs, diamond, or the like. The wavelength filter 13k and the like may be disposed at a predetermined incident angle that is larger than 0° with respect to an optical path axis of pulsed laser light in the laser apparatus. The wavelength-selective transmission film 211 may be formed of a multilayer film in which a high refractive index material and a low refractive index material are alternately laminated. As the high refractive index material, ZnSe, ZnS, or the like may be used, and as the low refractive index material, ThF₄, PbF₂, or the like may be used. As illustrated in FIG. 6, the wavelength-selective transmission film 211 may be so formed as to allow pulsed laser light in the 10.59-μm wavelength band to pass therethrough at high transmittance at a predetermined incident angle and as to reflect light in the 9.27-μm wavelength band, light in the 9.59-μm wavelength band, and light in 10.24 μm wavelength band at high reflectivity at the predetermined incident angle. FIG. 6 illustrates reflectivity characteristics in a case where the wavelength filter illustrated in FIG. 5 is so disposed as to allow the incident angle of entering light to be 5°.

5.2 Wavelength Filter Using a Plurality of Polarizers

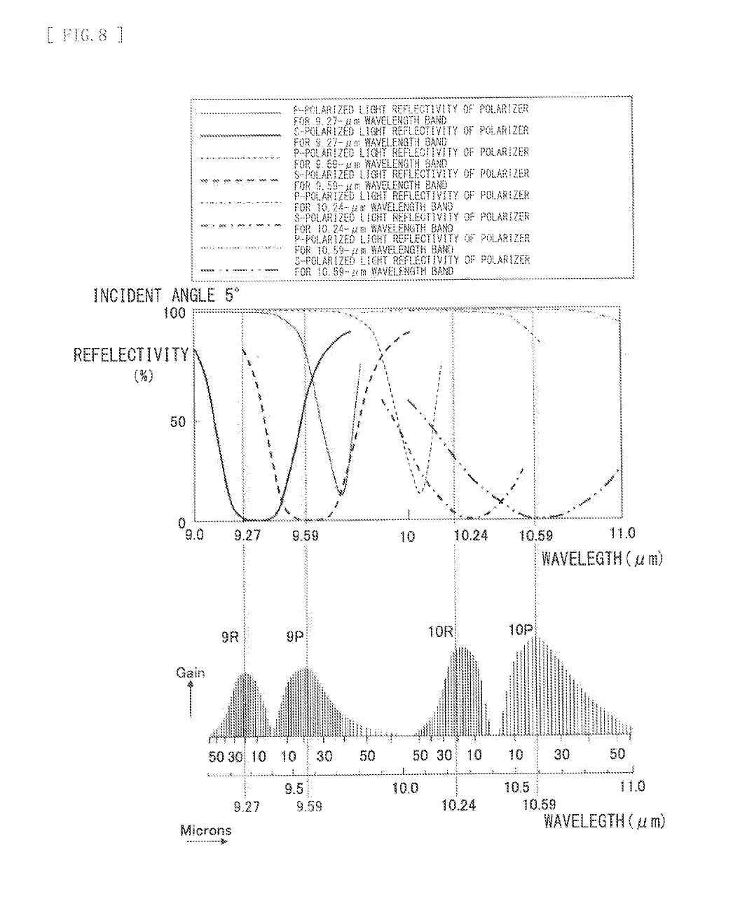

As illustrated in FIG. 7, each of the wavelength filter 13k and the like may be an optical system using a plurality of reflective polarizers, i.e., a first polarizer 221, a second polarizer 222, a third polarizer 223, a fourth polarizer 224, a fifth polarizer 225, and a sixth polarizer 226. The first polarizer 221 and the second polarizer 222 may be polarizers that absorb entered P-polarized light in the 9.27-μm wavelength band and reflect entered S-polarized light in the 9.27-μm wavelength band at high reflectivity. The third polarizer 223 and the fourth polarizer 224 may be polarizers that absorb entered P-polarized light in the 9.59-μm wavelength band and reflect entered S-polarized light in the 9.59-μm wavelength band at high reflectivity. The fifth polarizer 225 and the sixth polarizer 226 may be polarizers that absorb entered P-polarized light in the 10.24-μm wavelength band and reflect entered S-polarized light in the 10.24-μm wavelength band at high reflectivity.

The second polarizer 222 may be so disposed as to allow light in the 9.27-μm wavelength band reflected by the first polarizer 221 to enter as P-polarized light. In other words, the first polarizer 221 and the second polarizer 222 may be disposed in so-called crossed nicols. The fourth polarizer 224 may be so disposed as to allow light in the 9.59-μm wavelength band reflected by the third polarizer 223 to enter as P-polarized light. In other words, the third polarizer 223 and the fourth polarizer 224 may be disposed in so-called crossed nicols. The sixth polarizer 226 may be so disposed as to allow light in the 10.24-μm wavelength band reflected by the fifth polarizer 225 to enter as P-polarized light. In other words, the fifth polarizer 225 and the sixth polarizer 226 may be disposed in so-called crossed nicols.

Since the first polarizer 221, the second polarizer 222, the third polarizer 223, the fourth polarizer 224, the fifth polarizer 225, and the sixth polarizer 226 generate heat by absorbing P-polarized light, they may be cooled by a cooling system or the like that is unillustrated. This cooling system may be, for example, a cooling pipe or the like that allows cooling water to flow therethrough.

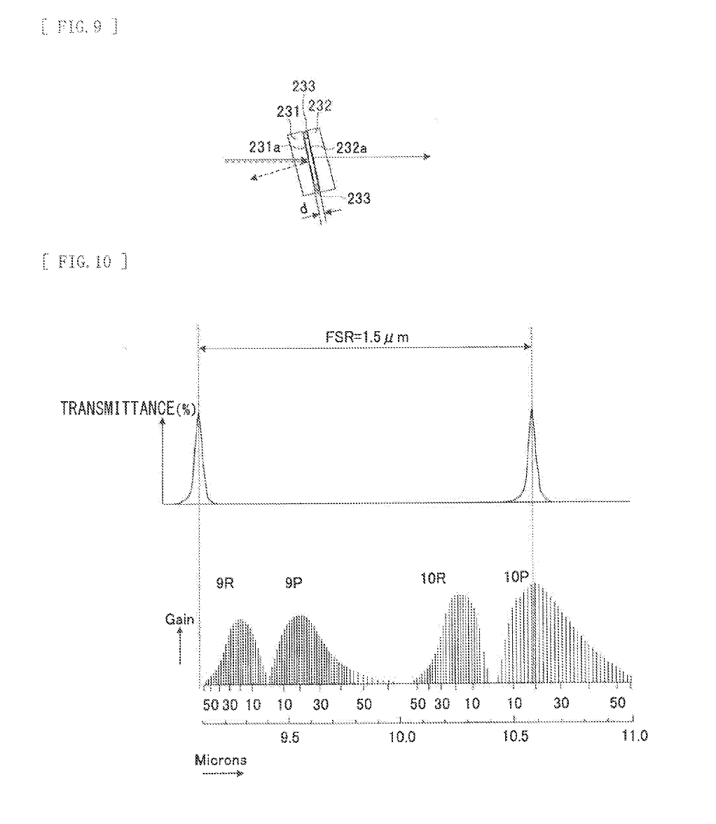

Therefore, in the wavelength filter 13k and the like illustrated in FIG. 7, light in the 9.27-μm wavelength band may be absorbed by the first polarizer 221 and the second polarizer 222. Light in the 9.59-μm wavelength band may be absorbed by the third polarizer 223 and the fourth polarizer 224. Light in the 10.24-μm wavelength band may be absorbed by the fifth polarizer 225 and the sixth polarizer 226. Thus, the light in the 9.27-μm wavelength band, the light in the 9.59-μm wavelength band, and the light in the 10.24-μm wavelength band may be absorbed by the wavelength filter illustrated in FIG. 7, and pulsed laser light included in the 10.59-μm wavelength band may be outputted. FIG. 8 illustrates reflectivity characteristics of P-polarized light and S-polarized light in a case where light enters, at an incident angle of 45°, polarizers for the 9.27-μm wavelength band, the 9.59-μm wavelength band, the 10.24-μm wavelength band, and the 10.59-μm wavelength band.

5.3 Wavelength Filter Using Etalon

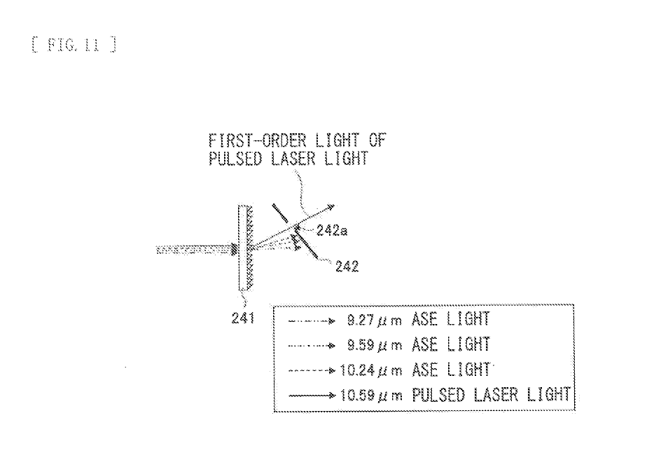

Each of the wavelength filter 13k and the like may be a wavelength filter using an etalon as illustrated in FIG. 9. More specifically, the etalon may be an etalon in which a partially reflective films 231a and 232a are formed on surfaces on one side of two substrates 231 and 232 formed of ZnSe or the like, and the surfaces where the partially reflective films 231a and 232a are formed of the substrates 231 and 232 face each other and are bonded together with a spacer 233 in between. Reflectivity of the thus-formed partially reflective films 231a and 232a may be 70 to 90%.

The etalon used in the wavelength filter may be preferably an air-gap etalon with an FSR (free spectral range) of 1.5 μm or more. For example, such an etalon may be so formed as to allow an interval d between the substrate 231 and the substrate 232 to be about 37.4 μm, based on the following expression (1), assuming that a wavelength λ of pulsed laser light is 10.59 μm, and a refractive index n of nitrogen gas is 1.000.

FSR=λ2/(2nd)=1.5 μm (1)

In this wavelength filter, a selective wavelength is allowed to be changed by changing an incident angle of light entering the etalon; therefore, the selective wavelength of the wavelength filter is allowed to be adjusted by changing the incident angle of the entered light. FIG. 10 illustrates transmittance characteristics of the wavelength filter illustrated in FIG. 9.

5.4 Wavelength Filter Including Grating and Slit

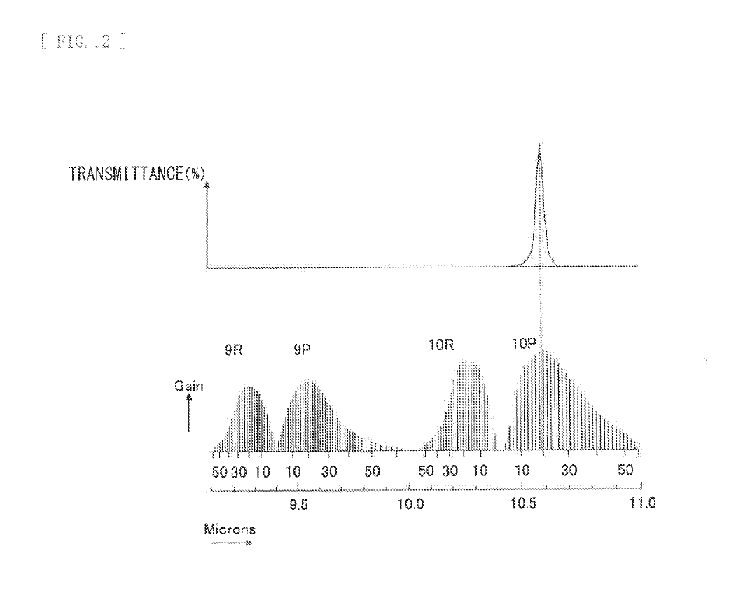

As illustrated in FIG. 11, each of the wavelength filter 13k and the like may include a grating 241 and a slit plate 242 in which a slit 242a is formed. The grating 241 may be a transmissive grating. The slit plate 242 may be so disposed as to allow first-order diffracted light in the 10.59-μm wavelength band generated by the grating 241 to pass through the slit 242a and as to shield ASE light in the 9.27-μm wavelength band, ASE light in 9.59-μm wavelength band, and ASE light in the 10.24-μm wavelength band. FIG. 12 illustrates transmittance characteristics of the wavelength filter illustrated in FIG. 11.

6. Combination of Wavelength Filter and EO Pockels Cell

6.1 Configuration

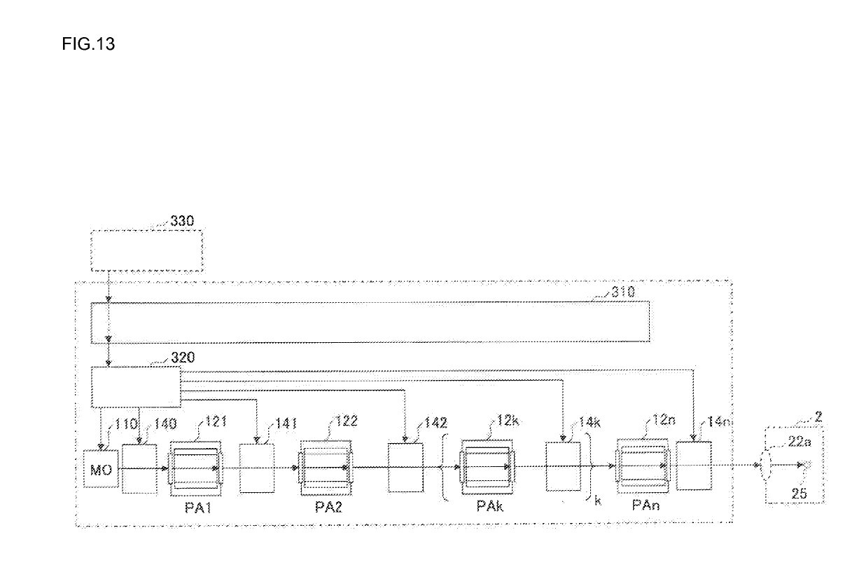

As illustrated in FIG. 13, in the laser apparatus of the present disclosure, optical isolators 140, 141, 142, . . . , 14k, . . . , and 14n may be provided between the MO 110 and the power amplifier 121 and adjacent two of the power amplifiers 12k and the like. All of the optical isolators 140, 141, 142, . . . , 14k, . . . , and 14n may be optical isolators with a same configuration.

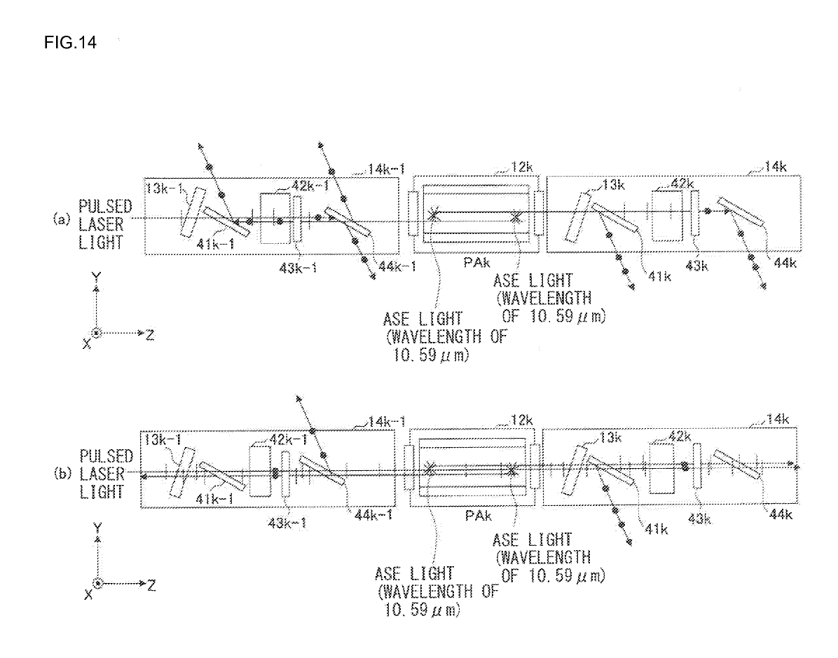

For example, as illustrated in FIG. 14, in the optical path of pulsed laser light, an optical isolator 14k-1 may be provided previous to the power amplifier 12k, and the optical isolator 14k may be provided following the power amplifier 12k. The optical isolator 14k may include the wavelength filter 13k, a first polarizer 41k, an EO Pockels cell 42k, a retarder 43k, and a second polarizer 44k. Likewise, the optical isolator 14k-1 may include the wavelength filter 13k-1, a first polarizer 41k-1, an EO Pockels cell 42k-1, a retarder 43k-1, and a second polarizer 44k-1. It is to be noted that FIG. 14(a) illustrates a state in which a voltage is not applied to the EO Pockels cell 42k or the like, and FIG. 14(b) illustrates a state in which a voltage is applied to the EO Pockels cell 42k or the like.

Moreover, as illustrated in FIG. 13 and the like, the laser apparatus of the present disclosure may include a laser control section 310 and a control circuit 320. The laser control section 310 may be connected to an external apparatus such as an EUV light generation system control section 330. The laser control section 310 and the control circuit 320 may be connected to each other. The control circuit 320 may be connected to the MO 110 and the optical isolators 140, 141, 142, . . . , 14k, . . . , and 14n.

The control circuit 320 may be connected to unillustrated power supplies that drive the respective EO Pockels cells 42k-1, 42k, and the like in the optical isolator 140, 141, 142, . . . , 14k, . . . , and 14n.

As illustrated in FIG. 14, the EO Pockels cell 42k or the like and the retarder 43k or the like may be disposed in an optical path of pulsed laser light between the first polarizer 41k or the like and the second polarizer 44k or the like. The wavelength filter 13k or the like may be disposed in any position in the optical path of pulsed laser light between adjacent two of the power amplifier 41k and the like.

The first polarizer 41k and the like and the second polarizer 44k and the like may reflect S-polarized light at high reflectivity and may allow P-polarized light to pass therethrough at high transmittance.

Each of the EO Pockels cell 42k and the like may be an EO Pockels cell that includes an electro-optic crystal, a pair of electrodes in contact with the electro-optic crystal, and a high-voltage supply, and is controlled to change a phase of entered light to 180° when a predetermined voltage is applied between the pair of electrodes by the high-voltage supply. Examples of such an electro-optic crystal may include CdTe crystal, GaAs crystal, and the like that are made possible to be used in a wavelength band of a CO₂ laser. Each of the retarder 43k and the like may be a λ/2 plate that changes a phase by 180°. Each of the retarder 43k and the like may be a λ/2 plate that provides a phase difference of 180°, i.e., a phase difference of ½ wavelength. The retarder 43k and the like may be so disposed as to set a slow axis thereof at 45° with respect to linearly polarized light when the linearly polarized light enters.

6.2 Operation

First, for example, a case where both the EO Pockels cell 42k-1 and the EO Pockels cell 42k are off will be described below with reference to FIG. 14(a).

Randomly polarized ASE light with a wavelength of 10.59 μm generated in the power amplifier 12k may travel toward a direction where the optical isolator 14k-1 is provided. In the optical isolator 14k-1, light of an S-polarized component of the entered ASE light may be reflected by the second polarizer 44k-1 at high reflectivity, and light of a (P) polarized component in the Y direction may pass through the second polarizer 44k-1 at high transmittance. The ASE light having passed through the second polarizer 44k-1 is linearly polarized light in the Y direction; therefore, the ASE light may be converted into linearly polarized light in the X direction by changing its phase by 180° by the retarder 43k-1. This linearly polarized light in the Y direction may pass through the EO Pockels cell 42k-1, and may enter the first polarizer 41k-1 as S-polarized light and be reflected by the first polarizer 41k-1 at high reflectivity. Accordingly, the randomly polarized ASE light with a wavelength of 10.59 μm that is generated in the power amplifier 12k and travels toward the direction where the optical isolator 14k-1 is provided may be prevented from entering an unillustrated power amplifier that is adjacent to the power amplifier 12k in a direction opposite to the traveling direction of pulsed laser light.

The randomly polarized ASE light with a wavelength of 10.59 μm generated in the power amplifier 12k may travel toward a direction where the optical isolator 14k is provided. In the optical isolator 14k, entered ASE light may pass through the wavelength filter 13k at high transmittance, and light of an S-polarized component may be reflected by the first polarizer 41k at high reflectivity, and light of a (P) polarized component in the Y direction may be pass through the first polarizer 41k at high transmittance. The ASE light having passed through the first polarizer 44 is linearly polarized light in the Y direction; therefore, after the ASE light passes through the EO Pockels cell 42k, the ASE light may be converted into linearly polarized light in the X direction by changing its phase by 180° by the retarder 43k. This linearly polarized light in the Y direction may enter the second polarizer 44k as S-polarized light and be reflected by the second polarizer 44k at high reflectivity. Accordingly, the randomly polarized ASE light with a wavelength of 10.59 μm that is generated in the power amplifier 12k and travels toward the direction where the optical isolator 14k is provided may be prevented from entering an unillustrated power amplifier that is adjacent to the power amplifier 12k in the traveling direction of pulsed laser light.

Next, for example, a case where both the EO Pockels cell 42k-1 and the EO Pockels cell 42k are on will be described below with reference to FIG. 14(b).

The randomly polarized ASE light with a wavelength of 10.59 μm generated in the power amplifier 12k may travel toward the direction where the optical isolator 14k-1 is provided. In the optical isolator 14k-1, light of an S-polarized component of the entered ASE light may be reflected by the second polarizer 44k-1 at high reflectivity, and light of a (P) polarized component in the Y direction may pass through the second polarizer 44k-1 at high transmittance. The ASE light having passed through the second polarizer 44k-1 is linearly polarized light in the Y direction; therefore, the ASE light may be converted into linearly polarized light in the X direction by changing its phase by 180° by the retarder 43k-1. This linearly polarized light in the X direction may be converted into linearly polarized light in the Y direction by changing its phase by 180° in the EO Pockels cell 42k-1. This linearly polarized light in the Y direction may enter the first polarizer 41k-1 as S-polarized light and pass through the first polarizer 41k-1 at high transmittance. Accordingly, ASE light of a polarized component in the X direction with a wavelength of 10.59 μm that is generated in the power amplifier 12k and travels toward the direction where the optical isolator 14k-1 is provided may pass through the optical isolator 14k-1.

The randomly polarized ASE light with a wavelength of 10.59 μm generated in the power amplifier 12k, and linearly polarized pulsed laser light in the Y direction that serves as seed light may travel toward the direction where the optical isolator 14k is provided. In the optical isolator 14k, the entered ASE light and the entered linearly polarized pulsed laser light in the Y direction may pass through the wavelength filter 13k at high transmittance. Then, light of an S-polarized component may be reflected by the first polarizer 41k at high reflectivity, and light of a (P) polarized component in the Y direction may pass through the first polarizer 41k at high transmittance. Each of the ASE light and the linearly polarized pulsed laser light in the Y direction serving as seed light that have passed through the first polarizer 41k is linearly polarized light in the Y direction; therefore, each of them may be converted into linearly polarized light in the X direction by changing its phase by 180° in the EO Pockets cell 42k. Moreover, the linearly polarized light in the X direction may be converted into linearly polarized light in the Y direction by changing its phase by 180° by the retarder 43k. Then, the linearly polarized light in the Y direction may enter the second polarizer 44k as P-polarized light and pass through the second polarizer 44k at high transmittance. Accordingly, the ASE light of a polarized component in the Y direction with a wavelength of 10.59 μm and linearly polarized pulsed laser light in the Y direction serving as seed light that are generated in the power amplifier 12k and travel toward the direction where the optical isolator 14k is provided may enter an unillustrated power amplifier that is adjacent to the power amplifier 12k in the traveling direction of pulsed laser light.

It is to be noted that description is given of light in a configuration in which the retarder 43k or the like is provided in the isolator 14k or the like, and the retarder 43k changes the phase of the light by 180° to rotate a polarization direction of the light by 90°. However, the retarder 43k or the like may not be provided in the isolator 14k or the like, and incident surfaces of the first polarizer 41k or the like and the second polarizer 44k or the like may be disposed orthogonal to each other.

6.3 Control

For example, the laser apparatus of the present disclosure may perform control to allow a timing at which the EO Pockels cell 42k-1 and the EO Pockels cell 42k are turned on to be synchronized with a timing at which pulsed laser light as seed light (with a pulse width of about 20 ns) passes therethrough. Time in which the EO Pockels cell 42k-1 and 42k are kept on may be about 30 to 100 ns. More specifically, when a trigger signal is inputted from an external apparatus such as the EUV light generation system control section 330 to a laser control section 310, the trigger signal may be inputted to the control circuit 320 through the laser control section 310. Thus, when the trigger signal is inputted to the control circuit 320, a trigger may be inputted from the control circuit 320 to the MO 110 to output pulsed laser light from the MO 110.

At a timing at which this pulsed laser light passes through the EO Pockels cell 42k or the like in the optical isolator 14k or the like, a predetermined pulse signal may be inputted from the control circuit 320 to a power supply of the EO Pockels cell 42k or the like. Accordingly, a potential may be applied to the EO Pockels cell 42k or the like for about 30 to about 100 nm, and pulsed laser light serving as seed light may pass through the EO Poeckels cell 42k or the like. The pulsed laser light serving as seed light may be amplified by the power amplifier 12k and the like by sequentially performing such an operation in the EO Pockets cell 42k and the like in the optical isolators 140, 141, 142, . . . , 14k, . . . , and 14n.

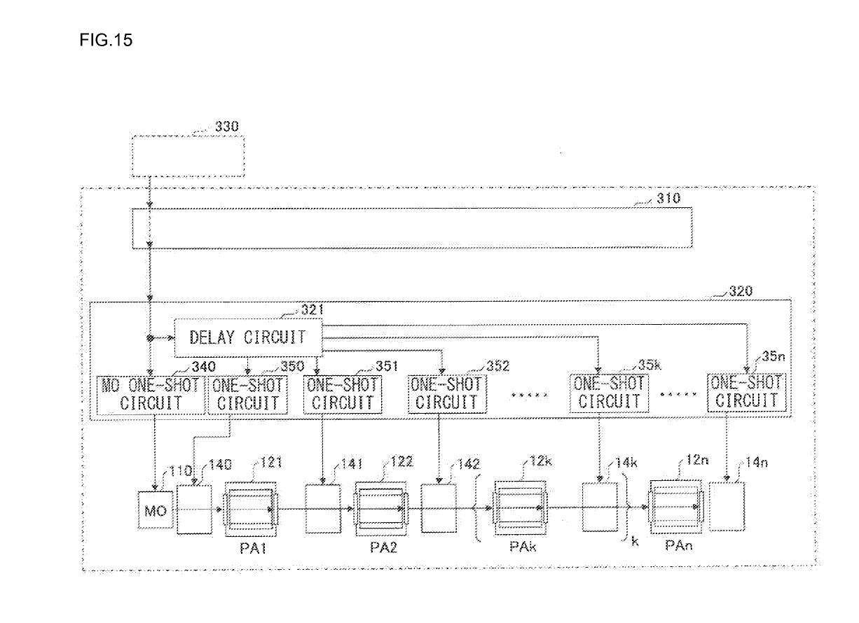

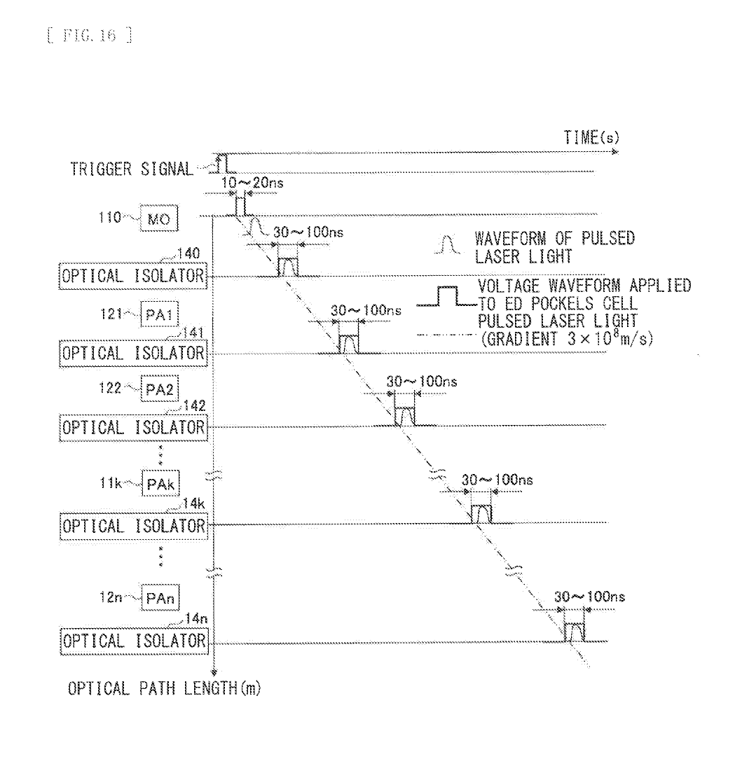

The above control will be described in more detail below with reference to FIGS. 15 and 16.

6.3.1 Configuration of Control Circuit

As illustrated in FIG. 15, the control circuit 320 may include a delay circuit 321, an MO one-shot circuit 340, and one-shot circuits 350, 351, 352, . . . , 35k, . . . , and 35n. A connection may be made such that an output of the MO one-shot circuit 340 is inputted to the MO 110. A connection may be made such that outputs in the one-shot circuits 350, 351, 352, . . . , 35k, . . . , and 35n are inputted to the respective optical isolators 140, 141, 142, . . . , 14k, . . . , and 14n. A connection may be made such that an output of the delay circuit 321 is inputted to the respective one-shot circuits 350, 351, 352, . . . , 35k, . . . , and 35n.

The MO one-shot circuit 340 may be so set as to output pulsed laser light with a desired pulse width, for example, as to output pulsed laser light with a pulse width of 10 to 20 ns.

6.3.2 Operation of Control Circuit

A trigger signal inputted from the external apparatus such as the EUV light generation system control section 330 to the laser control section 310 may be inputted to the delay circuit 321 and the MO one-shot circuit 340 in the control circuit 320.

As illustrated in FIG. 16, when the trigger signal is inputted to the delay circuit 321 and the MO one-shot circuit 340, pulse signals may be sequentially outputted from the MO one-shot circuit 340 and the one-shot circuits 350, 351, 352, . . . , 35k, . . . , and 35n.

The MO 110 may output pulsed laser light with a pulse width of 10 to 20 ns by the input of the pulse signal from the MO one-shot circuit 340. The optical isolators 140, 141, 142, . . . , 14k, . . . , and 14n may be so set as to be kept on for 30 to 100 ns by the input of pulse signals from the one-shot circuits 350, 351, 352, . . . , 35k, . . . , and 35n.

As illustrated in FIG. 16, the delay circuit 321 may be so set as to output a pulse signal delayed with respect to the inputted trigger signal from the one-shot circuits 350, 351, 352, . . . , 35k, . . . , and 35n. Each of the one-shot circuits 350, 351, 352, . . . , 35k, . . . , and 35n may be so set as to output a pulse signal with a longer pulse width than the pulse width of the pulsed laser light, for example, a pulse signal with a pulse width of 30 to 100 ns.

Accordingly, immediately before the pulsed laser light passes through each of the optical isolators 140, 141, 142, . . . , 14k, . . . , and 14n, each of the optical isolators 140, 141, 142, . . . , 14k, . . . , and 14n may be turned to a state in which the pulsed laser light is allowed to pass therethrough, and after the pulsed laser light passes therethrough, each of the optical isolators 140, 141, 142, . . . , 14k, . . . , and 14n may be turned to a state in which transmission of light is suppressed.

Thus, in the laser apparatus of the present disclosure, the optical isolator 14k and the like allow light to pass therethrough only when the pulsed laser light outputted from the MO 110 is caused to pass therethrough; therefore, self-oscillation in the 10.57-μm wavelength band may be suppressed to amplify pulsed laser light serving as seed light. Moreover, reflected light of the pulsed laser light applied to the target in the plasma generation region 25 in the chamber 2 may be prevented from entering the power amplifiers (121, 122, . . . , 12k, . . . , and 12n) and the MO (110).

6.4 Action

In the laser apparatus of the present disclosure, when pulsed laser light serving as seed light passes through the EO Pockels cell 14k or the like, the EO Pockels cell 14k or the like is turned on; therefore, self-oscillation of ASE light including the 10.59-μm wavelength band may be suppressed to amplify the pulsed laser light.

7. Combination of Wavelength Filter and Faraday Rotator

Each of the optical isolators 140, 141, 142, . . . , 14k, . . . , and 14n illustrated in FIG. 13 may be an optical isolator configured of a combination of a wavelength filter and a Faraday rotator.

7.1 Configuration

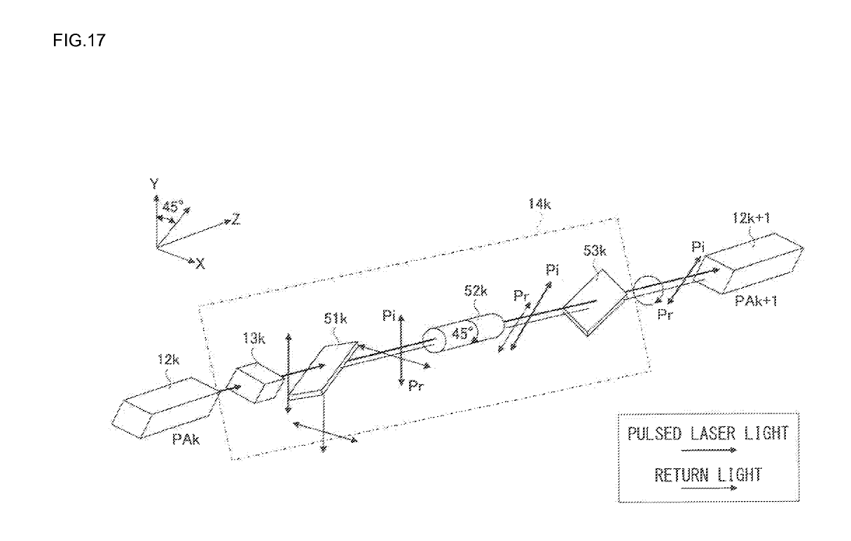

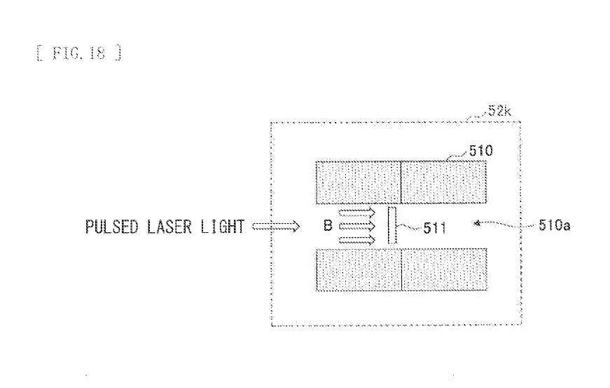

As illustrated in FIG. 17, the optical isolator 14k or the like may include the wavelength filter 13k or the like, a first polarizer 51k or the like, a Faraday rotator 52k or the like, and a second polarizer 53k or the like. Although the optical isolator 14k will be described as an example below with reference to FIG. 17, the optical isolators 140, 141, 142, . . . , 14k, . . . , and 14n may have a similar configuration.

The first polarizer 51k or the like and the second polarizer 53k or the like may be polarizers that reflect S-polarized light at high reflectivity and allow P-polarized light to pass therethrough at high transmittance. Incident surfaces of the first polarizer 51k or the like and the second polarizer 53k or the like may be so disposed as to form an angle of 45° with each other.

The Faraday rotator 52k or the like may be provided in an optical path of pulsed laser light between the first polarizer 51k or the like and the second polarizer 53k or the like.

The wavelength filter 13k or the like may be disposed in any position in the optical path of pulsed laser light between the power amplifier 12k or the like and a power amplifier adjacent thereto.

The wavelength filter 13k or the like may be a wavelength filter that allows light in the 10.59-μm wavelength band of the pulsed laser light serving as seed light to pass therethrough at high transmittance and attenuates light in the 9.27-μm wavelength band, light in the 9.59-μm wavelength band, and light in the 10.24-μm wavelength band. In other words, the wavelength filter 13k or the like may be an optical system that allows light in the 10.59-μm wavelength band of the pulsed laser light serving as seed light to pass therethrough at high transmittance and reflects or absorbs light in the 9.27-μm wavelength band, light in the 9.59-μm wavelength band, and light the 10.24-μm wavelength band at high reflectivity or high absorptance.

As illustrated in FIG. 18, the Faraday rotator 52k or the like may include a ring magnet 510 and a Faraday device 511 provided in an opening section 510a of the ring magnet 510. The Faraday rotator 52k or the like may be so disposed as to allow pulsed laser light to enter the opening section 510a of the ring magnet 510 and pass through the Faraday device 511. When the pulsed laser light passes through the Faraday device 511, a polarization angle of the pulsed laser light may be rotated. A rotation angle of the polarization angle is optical rotation 8, and is represented by the following (2), where magnetic flux density is B, a Verdet constant of a crystal of the Faraday device 511 is V, and a length of the crystal is L.

θ=VBL (2)

In the Faraday rotator 52k or the like, the magnetic flux B and the length L may be so set as to rotate the polarization direction of linearly polarized light in a clockwise direction by 45°. The Faraday device 511 in the Faraday rotator 52k or the like may include InSb, Ge, CdCr₂S₄, CoCr₂S₄, Hg₁₋ₓCdₓTe crystal, or the like.

7.2 Operation

As illustrated in FIG. 17, light traveling toward the traveling direction of pulsed laser light outputted from the power amplifier 12k or the like may enter the optical isolator 14k or the like and pass through the wavelength filter 13k or the like at high transmittance. Linearly polarized light of which the polarization direction is oriented in a vertical (Y-axis) direction of the pulsed laser light having passed through the wavelength filter 13k may pass through the first polarizer 51k or the like at high transmittance, and then may enter the Faraday rotator 52k or the like. The light having passed through the Faraday rotator 52k or the like may be converted into linearly polarized light of which the polarization direction is rotated in a clockwise direction (about the Y axis) by 45°. This light may pass through the second polarizer 53k or the like.

On the other hand, return light that is outputted from the power amplifier 12k+1 or the like and travels toward a direction opposite to the traveling direction of pulsed laser light may enter the optical isolator 14k or the like. A polarized component of which the polarization direction is inclined by 45° of the return light having entered the optical isolator 14k or the like may pass through the second polarizer 53k or the like at high transmittance, and this linearly polarized light of which the polarization direction is inclined by 45° may enter the Faraday rotator 52k or the like. In the Faraday rotator 52k or the like, the polarization direction of the entered light may be further rotated by 45°, and the entered light may be converted into linearly polarized light in a horizontal (X-axis) direction of which the polarization direction is rotated by 90°. The linearly polarized light in the horizontal direction may be reflected by the first polarizer 51k or the like at high reflectivity.

Thus, while light toward the traveling direction of pulsed laser light may pass through, transmission of light in a direction opposite to the traveling direction may be suppressed.

It is to be noted that light in the 9.27-μm wavelength band, light in the 9.59-μm wavelength band, and light in the 10.24-μm wavelength band of ASE light generated by the power amplifier 12k or the like may be attenuated by the wavelength filter 13k or the like.

7.3 Action

ASE light traveling toward a direction opposite to the traveling direction of pulsed laser light serving as seed light or light reflected by the target in the plasma generation region 25 in the chamber 2 may be attenuated by the Faraday rotator 52k or the like, the first polarizer 51k or the like, and the second polarizer 53k or the like. Also, ASE light with a wavelength different from the wavelength of the pulsed laser light serving as seed light may be suppressed by the wavelength filter 13k or the like.

7.4 Optical Isolator Including Reflective Polarizer

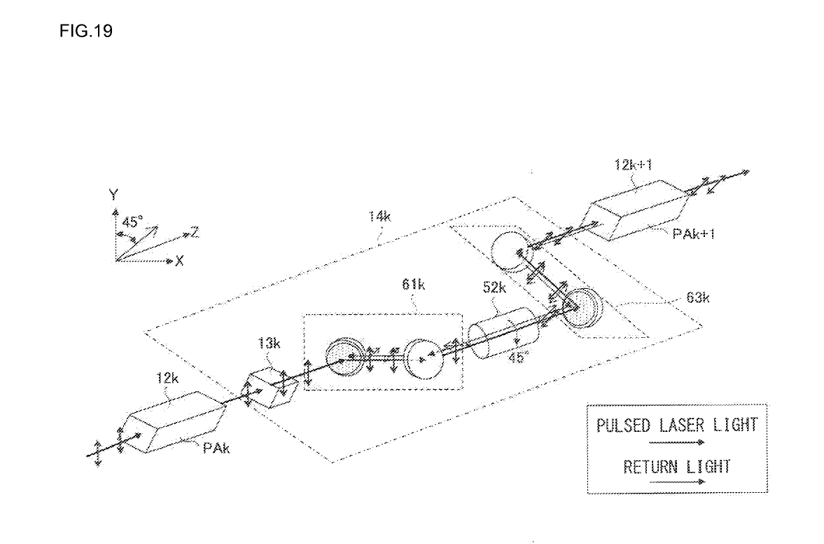

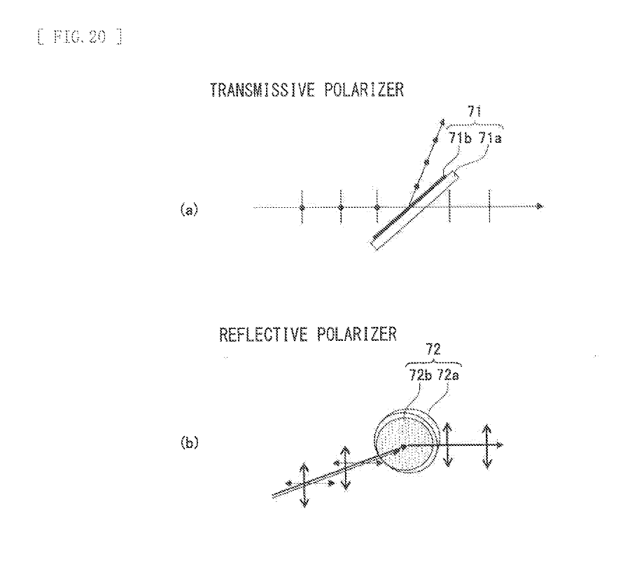

In the laser apparatus of the present disclosure, the optical isolator 14k including a reflective polarizer illustrated in FIG. 19 may be used.

An optical isolator including the reflective polarizer illustrated in FIG. 19 may be an optical isolator configured of a reflective first polarizer 61k and a reflective second polarizer 63k that are substituted for the first polarizer 51k and the second polarizer 53k in the optical isolator illustrated in FIG. 17, respectively. Moreover, as illustrated in FIG. 19, one reflective first polarizer 61k may be provided, or two or more reflective first polarizers 61k with same characteristics may be provided. Likewise, one reflective second polarizer 63k may be provided, or two or more reflective second polarizers 63k with same characteristics may be provided.

Since each of the first polarizer 61k and the second polarizer 63k is a reflective polarizer, each of the first polarizer 61k and the second polarizer 63k may absorb light in a predetermined polarization direction, and the temperature of the polarizer may be increased by the absorbed light, thereby causing deformation of a shape of a reflective surface thereof. When the shape of the reflective surface of the polarizer is deformed, aberration or the like may be caused in a wavefront in pulsed laser light. Therefore, in the optical isolator illustrated in FIG. 19, the first polarizer 61k and the second polarizer 63k may be cooled by providing a cooling channel for cooling on back surfaces or the like of the first polarizer 61k and the second polarizer 63k and feeding cooling water through the cooling channel. The occurrence of wavefront aberration when higher-power laser light passes through the first polarizer 61k and the second polarizer 63k may be suppressed by cooling the first polarizer 61k and the second polarizer 63k.

8. Polarizer

In the wavelength filter 13k and the like and the optical isolator 14k and the like of the laser apparatus of the present disclosure, polarizers may be used as described above. The polarizers may include a transmissive polarizer 71 illustrated in FIG. 20(a) and a reflective polarizer 72 illustrated in FIG. 20(b).

The transmissive polarizer 71 illustrated in FIG. 20(a) may be a polarizer in which a multilayer film 71b with predetermined spectral characteristics is formed on a surface of a substrate 71a that allows light to pass therethrough. The polarizer may reflect S-polarized light at high reflectivity and allow P-polarized light to pass therethrough at high transmittance. A material forming the substrate 71a may be a material including ZnSe, GaAs, diamond, or the like that allows CO₂ laser light to pass therethrough.

The reflective polarizer 72 illustrated in FIG. 20(b) may be a polarizer in which a multilayer film 72b with predetermined spectral characteristics is formed on a surface of a substrate 72a. The polarizer may reflect S-polarized light at high reflectivity and absorb P-polarized light. The reflective polarizer 72 is allowed to be cooled from a back surface of the substrate 72a; therefore, change in a wavefront of reflected laser light may be suppressed.

Moreover, in this embodiment, an example in which the substrate is coated with a film is described; however, a polarizer of a grid type or a polarizer in which a groove is processed may be used.

The foregoing description is intended to be merely illustrative rather than limiting. It should therefore be appreciated that variations may be made in embodiments of the disclosure by persons skilled in the art without departing from the scope as defined by the appended claims.

The terms used throughout the specification and the appended claims are to be construed as “open-ended” terms. For example, the term “includes/include/including” or “included” is to be construed as “including but not limited to”. The term “has/have/having” is to be construed as “having but not limited to”. Also, the indefinite article “a/an” described in the specification and recited in the appended claims is to be construed to mean “at least one” or “one or more”.

This application claims the priority benefit of Japanese Patent Application No. 2013-017271 filed on Jan. 31, 2013, and the entire content of Japanese Patent Application No. 2013-017271 is hereby incorporated by reference.

### REFERENCE SIGNS LIST

1 EUV light generation system
2 Chamber
3 Laser apparatus
4 Target sensor
5 EUV light generation control section
6 Exposure apparatus
21 Window
22 Laser light collecting mirror
22a Laser light condensing optical system
23 EUV collector minor
24 Through hole
25 Plasma generation region
26 Target feeding section
27 Target
28 Target collection section
29 Connection section
31 Pulsed laser light
32 Pulsed laser light
33 Pulsed laser light
34 Laser light traveling direction control section
41k-1, 41k First polarizer
42k-1, 42k EO Pockels cell
43k-1, 43k Retarder
44k-1, 44k Second polarizer
51k First polarizer
52k Faraday rotator
53k Second polarizer
61k First polarizer
63k Second polarizer
71 Transmissive polarizer
71a Substrate
71b Multilayer film
72 Reflective polarizer
72a Substrate
72b Multilayer film
110 MO
121 to 12n Power amplifier
130 to 13n Wavelength filter
140 to 14n Optical isolator
210 Substrate
211 Wavelength-selective transmission film
221 First polarizer
222 Second polarizer
223 Third polarizer
224 Fourth polarizer
225 Fifth polarizer
226 Sixth polarizer
231, 232 Substrate
231a, 232a Partially reflective film
233 Spacer
241 Grating
242 Slit plate
242a Slit
251 Radiation light
252 Reflected light
291 Wall
292 Intermediate condensing point (IF)
310 Laser control section
320 Control circuit
330 EUV light generation system control section
340 MO one-shot circuit
350 to 35n One-shot circuit
510 Ring magnet
510a Opening section
511 Faraday device

1. A laser apparatus comprising:
a master oscillator configured to output pulsed laser light;
a power amplifier disposed in an optical path of the pulsed laser light to amplify the pulsed laser light; and
a wavelength filter disposed between the master oscillator and the power amplifier in the optical path of the pulsed laser light, and configured to allow the pulsed laser light to pass therethrough and suppress transmission of light with a wavelength other than a wavelength of the pulsed laser light.

2. The laser apparatus according to claim 1, wherein the power amplifier includes a gas medium containing CO₂ laser gas.

3. The laser apparatus according to claim 2, wherein
the power amplifier generates light including two or more of a 9.27-μm wavelength band, a 9.59-μm wavelength band, a 10.24-μm wavelength band, and 10.59-μm wavelength band, and
the wavelength filter allows light in one of the wavelength bands generated in the power amplifier to pass therethrough, and suppresses transmission of light in wavelength bands other than the one wavelength band.

4. The laser apparatus according to claim 1, further comprising a first polarizer, a Pockets cell, a retarder, and a second polarizer that are provided between the master oscillator and the power amplifier in the optical path of the pulsed laser light.

5. The laser apparatus according to claim 4, wherein the Pockels cell changes a phase of the pulsed laser light at a timing at which the pulsed laser light passes through the Pockels cell.

6. The laser apparatus according to claim 1, further comprising a first polarizer, a Faraday rotator, and a second polarizer that are provided between the master oscillator and the power amplifier in the optical path of the pulsed laser light.

7. A laser apparatus comprising:
a master oscillator configured to output pulsed laser light;
two or more power amplifiers disposed in an optical path of the pulsed laser light and amplify the pulsed laser light; and
a wavelength filter disposed between adjacent two of the power amplifiers in the optical path of the pulse light, and configured to allow the pulsed laser light to pass therethrough and suppress transmission of light with a wavelength other than a wavelength of the pulsed laser light.

8. The laser apparatus according to claim 7, wherein the power amplifiers each include a gas medium containing CO₂ laser gas.

9. The laser apparatus according to claim 7, wherein the power amplifiers each generate light including two or more of a 9.27-μm wavelength band, a 9.59-μm wavelength band, a 10.24-μm wavelength band, and 10.59-μm wavelength band, and
the wavelength filter allows light in one of the wavelength bands generated in the power amplifier to pass therethrough, and suppress transmission of the light in wavelength bands other than the one wavelength band.

10. The laser apparatus according to claim 7, further comprising a first polarizer, a Pockels cell, a retarder, and a second polarizer that are provided between adjacent two of the power amplifiers in the optical path of the pulsed laser light.

11. The laser apparatus according to claim 10, wherein the Pockels cell changes a phase of the pulsed laser light at a timing at which the pulsed laser light passes through the Pockels cell.

12. The laser apparatus according to claim 7, further comprising a first polarizer, a Faraday rotator, and a second polarizer that are provided between adjacent two of the power amplifiers in the optical path of the pulsed laser light.

13. A laser apparatus comprising:
a master oscillator configured to output pulsed laser light;
two or more power amplifiers disposed in an optical path of the pulsed laser light to amplify the pulsed laser light; and
a first polarizer, a Pockels cell, a retarder, and a second polarizer that are provided between adjacent two of the power amplifiers in the optical path of the pulsed laser light.

14. The laser apparatus according to claim 13, wherein the Pockels cell changes a phase of the pulsed laser light at a timing at which the pulsed laser light passes through the Pockels cell.

15. The laser apparatus according to claim 13, wherein the power amplifiers each include a gas medium containing CO₂ laser gas.

16. A laser apparatus comprising:
a master oscillator configured to output pulsed laser light;
two or more power amplifiers disposed in an optical path of the pulsed laser light to amplify the pulsed laser light; and
a first polarizer, a Faraday rotator, and a second polarizer that are provided between adjacent two of the power amplifiers in the optical path of the pulsed laser light.

17. The laser apparatus according to claim 16, wherein the power amplifiers each include a gas medium containing CO₂ laser gas.

18. An extreme ultraviolet light generation system comprising:
the laser apparatus according to claim 1;
a chamber;
a target generation section configured to feed a target into the chamber; and
a condensing optical device configured to condense pulsed laser light outputted from the laser apparatus to apply the pulsed laser light to the target in the chamber.

19. An extreme ultraviolet light generation system comprising:
the laser apparatus according to claim 7;
a chamber;
a target generation section configured to feed a target into the chamber; and
a condensing optical device configured to condense pulsed laser light outputted from the laser apparatus to apply the pulsed laser light to the target in the chamber.

20. An extreme ultraviolet light generation system comprising:
the laser apparatus according to claim 13;
a chamber;
a target generation section configured to feed a target into the chamber; and
a condensing optical device configured to condense pulsed laser light outputted from the laser apparatus to apply the pulsed laser light to the target in the chamber.

21. An extreme ultraviolet light generation system comprising:
the laser apparatus according to claim 16;
a chamber;
a target generation section configured to feed a target into the chamber; and
a condensing optical device configured to condense pulsed laser light outputted from the laser apparatus to apply the pulsed laser light to the target in the chamber.
